(19) United States
(12) Patent Application Publication
(10) Pub. No.: US 2010/0148927 A1
(43) Pub. Date: Jun. 17, 2010

(54) SYSTEM FOR MANAGING INFORMATION IN RELATION TO A PET ANIMAL CARRYING SUBCUTANEOUS ELECTRONIC IDENTIFICATION DEVICE

(75) Inventors: Johan De Meulemeester, De Pinte (BE); Dominique Boiron, Vitre (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: ALLFLEX EUROPE, Vitre (FR)

(21) Appl. No.: 12/635,283

(22) Filed: Dec. 10, 2009

(30) Foreign Application Priority Data
Dec. 10, 2008 (FR) 08/58454

(51) Int. Cl. H04Q 5/22; G06F 3/02

(52) U.S. Cl. 340/10.1; 345/168

(57) ABSTRACT

A system is provided for managing information in relation to a pet animal carrying subcutaneous electronic identification device, said system including: A reader, which reads a piece of identification information contained in the electronic identification device; at least one scale, which measures at least one physical datum associated with the animal; a device for storing and/or transmitting the at least one physical datum, while taking the identification information into account. The reader is built into the scale.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the identification and monitoring of animals.

To be more precise, the disclosure relates to the management of information in relation to a pet animal carrying a subcutaneous implant that includes electronic identification means.

### BACKGROUND OF THE DISCLOSURE

The identification of household animals or pets has been made compulsory in many countries. Thus, in France, pet animals such as dogs or cats have had to be able to be identified by a tattoo or an electronic chip for a number of years. Said identification allows the animal to be listed in a file, in which the contact details of its owner are given.

Over recent years a development has been seen in the electronic means for identifying animals, and in particular in the electronic chips for implanting under the skin of a pet animal. Conventionally, an electronic chip is implanted into the neck of the animal. Such chips have numerous advantages, in that they are easy and painless to fit for example, and in that they afford reliable animal identification since said chips remain readable throughout the life of the animal and are theoretically forgery-proof, etc.

Said chips come in the form of a transponder that generally includes a coil associated with an electronic element with built-in data communication and storage functions, encapsulated in a glass ampoule. The electronic element bears in particular an identification number, or ID, for the animal which can be used to monitor it throughout its existence.

Such transponders are described in particular in the American U.S. Pat. No. 5,025,550 and U.S. Pat. No. 5,281,855.

At the present time, said pet identification means, electronic or otherwise, are only used to monitor the animals for statistical and administrative reasons and to identify their owners.

### SUMMARY

An exemplary embodiment of the disclosure proposes a new use for the electronic identification means, and comes in the form of a system for managing information in relation to at least one pet animal carrying subcutaneous electronic identification means, said system comprising:
means for reading a piece of identification information contained in the electronic identification means;
means for measuring at least one physical datum associated with the animal;
means for storing and/or transmitting the physical datum or data, while taking the identification information into account.

According to an embodiment of the disclosure, said means for measuring include at least one scale and said means for reading are built into said scale.

An embodiment of the disclosure thus proposes a new use for the electronic identification means, allowing the household animals or pets to be “physically” tracked. A pet animal is here taken to mean any animal that is kept or intended to be kept by man for his own pleasure.

To this end, an embodiment of the disclosure proposes a system for measuring one or more pieces of physical (or physiological, morphological, etc.) data associated with the animal, such as its weight, its temperature, its height etc., and for automatically associating said measured data with the animal ID.

Such a system comprises at least one scale, making it possible to measure the weight of the animal and to monitor changes in said weight throughout the animal's existence.

Also, the means for reading are built into or secured to the scales.

The animal has thus simply to be positioned on the scales in order to:
measure at least one physical datum associated with the animal, in this case its weight; and
read a piece of identification information contained in the electronic identification means.

Said identification and weight information may be stored in a memory, or transmitted to a remote device.

Said association is implemented automatically, in other words with no external intervention, such as the intervention of a veterinary surgeon or the animal's owner for example. Said system therefore operates autonomously.

It is then possible to store the measured data associated with the animal ID in a memory, for example in the form of a list, including for one or more animals:
a piece of animal identification information (identification number for example);
one or more pieces of physical data related to said identification information.

It is noted that said physical data may be measured at different dates. According to this aspect, the inventive system includes means for associating a date with at least one physical datum.

It is also possible to transmit the measured data to a remote device, possibly after recording said data. For example, said data may be sent to the veterinary surgeon in charge of the animal or to the owner of the animal, on their computers. The identification information may be transmitted together with said data, or be used solely to identify the owner of the animal and to transmit said data to him (on his electronic messaging service for example).

According to one particular aspect of the disclosure, the means for reading include at least one antenna of the coiled loop antenna type.

For example, said antenna may be non-plane in order to cover different orientations of the electronic identification means located in the field of the antenna.

The antenna may be mobile around an axis of the scales, in order to improve the reading of the electronic identification means.

According to one alternative, the means for reading are built into a detachable reader. Said reader may communicate with the means for storing and/or transmitting via a wire or wireless connection. It is for example built into a computer mouse.

Said alternative requires a user, such as the owner of the animal for example, to “scan” the animal's electronic chip. The measured data are then automatically associated with the animal's ID.

According to one particular feature, the information management system includes at least one processor, thereby allowing the measured physical datum or data to be linked with the identification information.

Said processor is controlled by a computer program product thereby allowing the identification information to be linked with different information, such as the measured physical data, the name of the animal or of the owner, a weight record, etc.,

It may be built into the means for measuring, such as into a set of scales for example. It may communicate with a memory storing the measured data, possibly associated with a date and with an identification number. It may also communicate with means for transmitting the measured datum or data.

In particular, said processor may deliver a piece of comparison information between at least one previously measured physical datum and a current physical datum, associated with the animal.

For example, the processor is able to compare the weight of the animal measured on a given day with the weight of the same animal as measured earlier and stored in a memory (found in the scales for example, or in a remote device).

The processor is then able to deliver at least one recommendation as a function of an analysis of said comparison information. For example, if the animal has put on weight, and is overweight relative to a reference curve, a recommendation in relation to the animal's diet may be delivered, such as a quantity of food per day, a particular type of pet food, etc.,

In particular, the information management system may include at least one loudspeaker. The system may also be fitted with a voice synthesis system, allowing the voice message to be personalized.

For example, if the animal is a dog called “Rex”, the system may issue a message such as “Today Rex weighs x kg”.

In the same way, the recommendation may be issued in oral form. For example “Rex has put on y kg since he was weighed on d. We recommend the use of low fat pet food”.

According to one inventive embodiment, the management information system includes means for displaying and/or inputting animal-related information.

For example, said for displaying and/or entering include at least one element belonging to the group that includes:
a display screen;
a touch screen;
a programming keypad.

The means for displaying can be used in particular to display advertising or informational messages.

According to one particular aspect of the disclosure, the means for storing and/or transmitting the information management system engage with at least one connection thereby allowing at least the measured physical datum or data to be transferred to an external unit.

Said external unit, also termed remote device, corresponds for example to the computer belonging to the veterinary surgeon, his assistant, or the owner, or a communication terminal of the owner such as a mobile telephone or personal assistant such as a Personal Digital Assistant (PDA), etc.

For example, the connection belongs to the group that includes:
a Universal Serial Bus (USB) connection;
a serial connection;
an Ethernet connection;
a Bluetooth (trademark) connection;
a Wi-Fi connection.

In this way, it is possible to connect a USB key (to the scales for example) in order to retrieve the information stored in the storage means. It is also possible to communicate remotely with the scales.

The disclosure also relates to a set of scales fitted with means for reading a piece of identification information contained in electronic identification means fitted to a pet animal.

### BRIEF DESCRIPTION OF THE DRAWINGS

Other features and advantages of the disclosure will become clearer from reading the following description of one particular embodiment, given simply as an illustrative and non-restrictive example, and the appended drawings, wherein:

FIG. 1 shows the general principle of a system of managing information in relation to a pet animal carrying an electronic chip according to one particular inventive embodiment;

FIGS. 2A and 2B show two antenna structures that may be used to read the animal identification information stored in the electronic chip;

FIG. 3 shows the interactions between the system according to one particular inventive embodiment and remote devices.

### DETAILED DESCRIPTION OF ILLUSTRATIVE EMBODIMENTS

The general inventive principle lies in the automatic association or one or more pieces of physical data about a household animal or pet, with a piece of animal identification information contained in a subcutaneous electronic identification device, such as a device commonly known as an electronic chip.

The disclosure thus proposes a new use for the electronic identification device that allows said animals to be physically (or physiologically, morphologically, etc.,) monitored, in terms for example of their weight, their height, their temperature, etc.

To this end, the disclosure proposes a system for managing information in relation to one or more animals as shown in FIG. 1. Said system includes:
a reader, which reads a piece of identification information contained in the electronic identification device 10 implanted under the skin of an animal (for example of the radio-frequency identification or RFID type);
a measuring device, which measures 12 at least one physical datum associated with the animal;
a device 13 which stores and/or transmits 13 the measured physical datum or data, while taking the identification information into account.

The measured data can be stored in a database 14, matching the measured data and the corresponding animal identification information, and possibly the day's date. It is thus possible to monitor changes to the animal, by its weight or its height for example.

A description is given hereinafter of a particular example of the disclosure, according to which the measuring device for measuring at least one physical datum associated with the animal (cat or dog for example) includes a set of scales comprising a weigh plate. The weight of the animal is then measured. Clearly, this example is purely illustrative, and non-restrictive, and other physical features of the animal, such as its height, its temperature etc., could be measured.

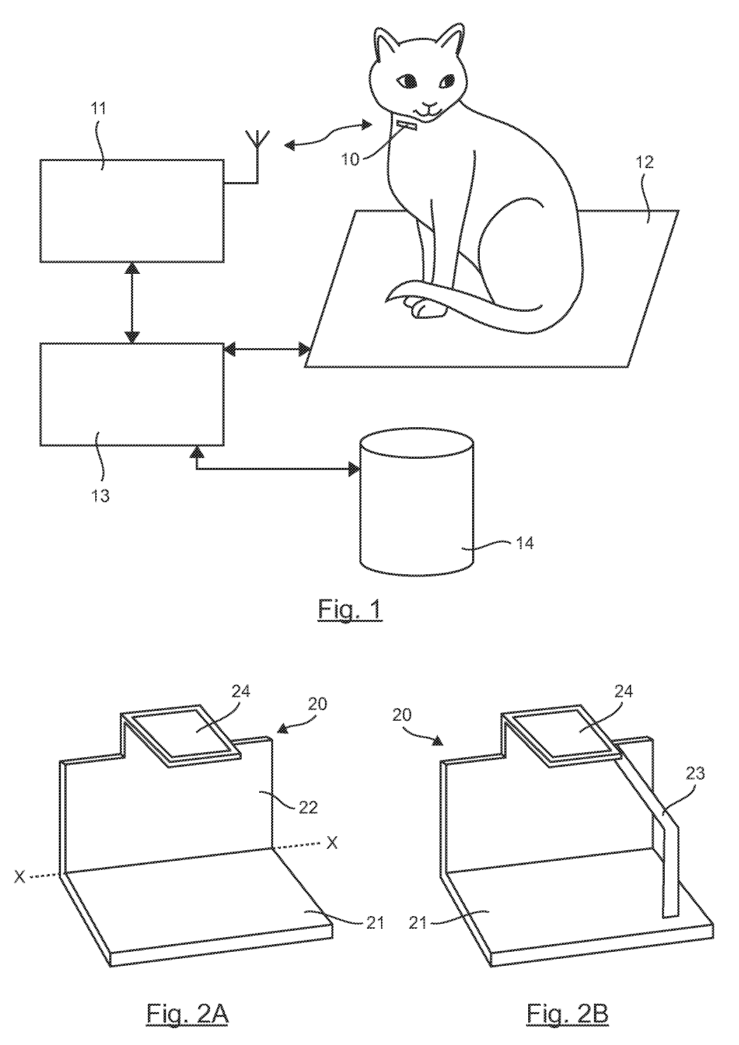

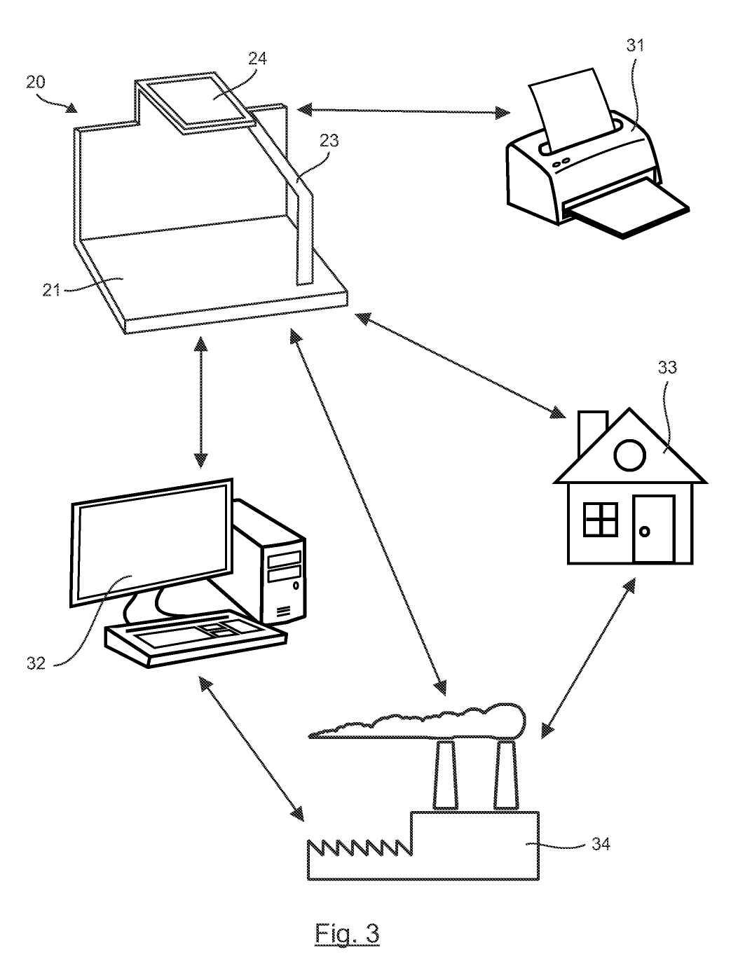

As shown in FIGS. 2A and 2B, the reader includes at least one antenna associated with a weigh plate 21.

To be more precise, according to FIG. 2A, the antenna may be built into a wall 22 of the scales 20, and take the form of a coiled loop antenna, or a wire loop. Its diagram is then perpendicular to the plane of the loop, in order to be able to retrieve the information held in an electronic chip implanted under the skin of an animal placed on the weigh plate 21.

According to one alternative shown in FIG. 2B, the antenna takes the form of an arm 23 that can be folded around the animal, improving the reading of the electronic identification device. Indeed, using a non-plane antenna that different orientations of the electronic chip located in the field of the antenna can be covered. For example, if said chip takes the form of a cylinder, it is possible to read the information it carries whatever the orientation of the cylinder.

According to another alternative, the antenna may be mobile around an axis of the scales. This allows the electronic chip reading to be improved, in particular by bringing the antenna closer to the animal. For example, the wall 22 is mobile relative to the weigh plate 21, around the axis XX located at the intersection of the wall 22 and the weigh plate 21.

The antenna may also be a non-plane antenna built into the wall 22 and the element 24. The angle between the wall 22 and the element 24 may then be adapted to take account of the mobility of the wall 22.

Other antenna types or geometry are also conceivable, as long as they allow information carried by subcutaneous electronic identification device to be read (or received).

In other words, the antenna is positioned in order to optimize the reading of the animal's subcutaneous or intramuscular chip.

A set of scales 20 in accordance with FIGS. 2A and 2B may for example be moved and installed in a veterinary surgeon's waiting or consulting room, in a pharmacy, in a shopping precinct, etc., so that the weight of the animal in particular can be monitored.

Dimensions of the scale 20 are limited to household animals or pets, the scale being configure to receive animals weighing between 150 et 200 kg for example.

For example, when the owner of an animal brings said animal to the veterinary surgeon's in order to have it vaccinated, the animal's owner may avail himself of this service to check the weight of his animal, while waiting for the veterinary surgeon to take over.

To this end, the animal needs only to be placed onto the weigh plate 21 in order to be weighed. The antenna included in the wall 22 and/or the collapsible antenna 23 then receives (or reads) a piece of animal identification information, contained in the animal's subcutaneous chip.

The animal's weight is then stored and/or transmitted, taking the identification information into account. To this end, the scales 20 include at least one connection (or one port) allowing a transfer to an external unit and/or a memory. For example, the animal's weight is stored in the database 14, in relation to the day's date and the animal's identification number. It is also possible to transmit the weight measured at the home of the animal's owner, on a computer for example, using the identification information to identify the animal's owner and his e-mail address for example.

The so-called “intelligent” scales 20 thus include at least one processor, controlled by a computer program product thereby allowing an identification number of the animal to be linked with different information, such as the name of the animal or the owner thereof, the current measured datum, at least one previously measured datum, etc.

As shown in FIG. 3, a printer 31 may also be connected to the scales 20, or built into the scales 20. In this way, the owner is able to print out a graph showing changes in the animal's weight (or height, temperature, etc.) over time, taking into account data associated with the animal and previously stored in the database 14.

Other connections are possible, such as a USB, serial, Ethernet, Bluetooth (trademark), or Wi-Fi connection, etc.

The animal's owner is thus able to load the measured data onto a USB key for example.

According to one alternative, the scales 20 may also communicate (via a Bluetooth wireless connection for example) with the computer 32 of the veterinary surgeon, who is able to monitor the animal, or with a terminal of the owner, such as his mobile telephone or his PDA.

If the measured data are communicated to the computer 32 of the veterinary surgeon, said data may be accessible for the owner through the veterinary surgeon's Internet site, via the identification number held in the animal's chip for example.

Conversely, if the owner of the animal has said set of scales available at his home 33, the data can be transferred to the veterinary surgeon.

According to the particular example described, the scales 20 also include a loud-speaker, and voice synthesis means.

The scales 20 can thus recognize the animal by means of its chip, and communicate with the owner in a customized way. For example, once the animal is weighted and recognized, the scales may emit a voice message such as “Good morning Mr (name of owner), the body weight registered today by (name of animal) is 5.650 kg, i.e. a drop of 600 g compared with the last visit on (date of last visit)”.

The scales may also be fitted with a screen 24, for example a touch screen, so that the animal's weight in particular can be displayed.

For example, said touch screen (or conventional keypad) may be used to enter the name of the owner and of his animal, the e-mail address of the owner etc., in correspondence with the animal's ID carried by the electronic chip. Said information may be memorized in the database 14, in relation to the identification information contained in the electronic chip for example.

Said screen 24 may also be dissociated from the scales 20, and communicate with the scales 20 via a wire or wireless connection.

Moreover, it is possible to display on the screen 24 advertisements, or recommendations addressed to the animal owner for example. The advertisements originate for example with pharmaceutical firms or animal food distributors 34, and may be regularly updated by said firms and distributors 34. They may change in line with the seasons (by offering products to fight against fleas or ticks in summer or in autumn), in line with a visit from a representative, and may be targeted in line with the animal or animal monitoring (special low-fat cat food offered if a cat is overweight for example, or a worming product if the cat has lost weight). They may also offer exercises adapted to the animal, advice on dieting, etc.

The pharmaceutical firms or food distributors 34 may also communicate with the veterinary surgeon's computer 32, for example via an Internet connection, in particular when the computer 32 centralizes the animal-related information. For example, it is possible to build statistics about the weight of the animals and any overweight thereof, and to communicate said information to the firms or to the food distributors 34.

The firms or food distributors 34 may then make promotional offers to the veterinary surgeon, on his computer 32, targeted in line with the animal profile, for new food or medicinal products, etc.

It is also possible to display on said screen the measured weight of the animal and the reference weight of an animal of the same sex, same race, etc, so that the owner of the animal is able to check that his animal is about average. Said information on ideal weight relative to the race of the animal may also be printed using the printer 31. It is also possible to display a target weight which the animal ought to reach (entered by the owner or determined as a function of ideal weight curves), and recommendations as to how the animal should reach said target weight (in the form of a series of exercises, dietary recommendations, etc., suggested and updated by the firms or food distributors 34).

Other customized information related to the identification information on the animal's electronic chip may also be displayed.

The inventive system is thus particularly advantageous on account of its autonomy, in the sense that no external intervention, such as the intervention of a veterinary surgeon or the owner of the animal, is necessary. Personnel costs for the veterinary surgeon are therefore reduced when the system is installed in the veterinary surgeon's waiting room.

Although in the example described, the different elements are built into the scales, this example is not restrictive.

For example, the reader may be removable, and may communicate with the processor and/or a memory and/or the database 14 via a wire or wireless connection. In other words, the antenna 23 is not necessarily built into the scales, but may be offset.

In the same way, the physical data storage device may be held in the scales in the form of a memory, or offset in the computer 32 of the veterinary surgeon or a terminal of the owner. The storage device may also be a removable storage device of the USB key type.

According to one alternative, the reader takes the form of a portable reader, which transfers the identification information contained in the electronic identification device to a processor.

Said portable reader is for example used by the owner of the animal at his home 33. It is thus able to communicate with the animal owner's computer. For example, said reader is built into the mouse of the owner's computer. According to one alternative, said reader is an independent reader, which is able to be recharged or transmit the information it has read when it is placed on a support connected to a USB port of the computer.

Said reader, even if it does not communicate with the scales 20, can be used to inform the owner of his animal's ID, and to access information in relation to his animal on the veterinary surgeon's site, or specific information offered on the site of pharmaceutical firms or food distributors 34, by means of said ID.

The pharmaceutical firms or food distributors 34 may, via their Internet site for example, communicate directly to the owner's computer information in relation to his animal, to exercises, diet, vaccines etc. that are appropriate for his animal.

Clearly the example presented in relation to the measurement of an animal's weight is not restrictive. Other physical or physiological features of the animal may be measured, such as its height, its temperature, its heartbeat, etc, and automatically associated with the animal's ID, without departing from the inventive protection field. It is necessary to this end for the animal to carry an electronic identification device, or an electronic chip.

Although the present disclosure has been described with reference to one or more examples, workers skilled in the art will recognize that changes may be made in form and detail without departing from the scope of the disclosure and/or the appended claims.

What is claimed is:

1. A system for managing information in relation to at least one pet animal carrying subcutaneous electronic identification means, said system comprising:
means for reading a piece of identification information contained in said electronic identification means;
means for measuring at least one physical datum associated with said animal;
means for storing and/or transmitting said at least one physical datum, while taking said identification information into account,
wherein said means for measuring include at least one scale and said means for reading are built into said scale.

2. The system according to claim 1, wherein said means for reading include at least one antenna which is mobile around an axis of said scale.

3. The system as claimed in claim 1, wherein said means for reading are built into a removable reader.

4. The system as claimed in claim 1, wherein the system includes means for associating a date with said at least one physical datum.

5. The system as claimed in claim 1, wherein the system includes at least one processor, thereby allowing said at least one physical datum to be linked with said identification information.

6. The system as claimed in claim 5, wherein said processor delivers a piece of comparison information between at least one previously measured physical datum and one current physical datum, associated with said animal.

7. The system as claimed in claim 6, wherein said processor delivers at least one recommendation as a function of an analysis of said comparison information.

8. The system as claimed in claim 1, wherein the system includes at least one loud-speaker.

9. The system as claimed in claim 1, wherein the system includes means for displaying and/or inputting information linked with said animal.

10. The system as claimed in claim 9, wherein said means for displaying and/or inputting include at least one element belonging to the group that includes:
a display screen;
a touch screen;
a programming keypad.

11. The system as claimed in claim 1, wherein said storage and/or transmission means engage with at least one connection thereby allowing at least said physical datum to be transferred to an external unit.

12. The system as claimed in claim 11, wherein said at least one connection belongs to the group that includes:
a Universal Serial Bus (USB) connection;
a serial connection;
an Ethernet connection;
a Bluetooth (trademark) connection;
a Wi-Fi connection.

13. A system for managing information in relation to at least one pet animal carrying subcutaneous electronic identification device, said system comprising:
at least one scale, which measures at least one physical datum associated with said animal;
reader built into said scale and adapted to read a piece of identification information contained in said electronic identification device;
a device, which stores and/or transmits said at least one physical datum, while taking said identification information into account.
